(19) United States
(12) Patent Application Publication
(10) Pub. No.: US 2024/0178657 A1
(43) Pub. Date: May 30, 2024

(54) POWER SAVING SYSTEMS AND METHODS FOR ISOLATION CIRCUITRY IN A VOLTAGE SENSING ACCESSORY

(71) Applicant: Illinois Tool Works Inc., Glenview, IL (US)

(72) Inventor: Brian Lee Ott, Sherwood, WI (US)

(21) Appl. No.: 18/520,637

(22) Filed: Nov. 28, 2023

Related U.S. Application Data
(60) Provisional application No. 63/428,448, filed on Nov. 29, 2022.

(51) Int. Cl. H02H 7/20; B23K 9/095; H02H 1/00

(52) U.S. Cl. CPC H02H 7/20; B23K 9/0953; H02H 1/0007

(57) ABSTRACT

Systems and methods are disclosed for controlling isolation circuitry in a welding device based on one or more power characteristics. In particular, a power supply and a welding wire feeder are provided to support both arc welding and gouging operations. To ensure power at an output power terminal is available only during periods of operation, isolation circuitry is provided in the wire feeder. The isolation circuitry is operable to create a path between a input power terminal and an output terminal during an arc welding and/or gouging operation, and to electrically or physically disrupt the path between the input power terminal and the output power terminal during an idle or standby mode.

### CROSS REFERENCE TO RELATED APPLICATIONS

This application is a Non-Provisional Patent Application of U.S. Provisional Patent Application No. 63/428,448 entitled “Power Saving Systems And Methods For Isolation Circuitry In A Voltage Sensing Accessory” filed Nov. 29, 2022, which is herein incorporated by reference in its entirety.

### BACKGROUND

Welding is a process that has become ubiquitous in nearly all industries. Conventional systems and methods for short circuit welding processes, such as welding, brazing, adhesive bonding, and/or other joining operations, require substantial investments in equipment, such as processing, displays, practice workpieces, welding tool(s), sensor(s), and/or other equipment.

Conventional welding systems may be capable of operating in multiple modes, such as an arc welding mode or a gouging mode. However, during periods of inactivity, output terminals are often provided with power unnecessarily.

Thus, systems and methods that provide effective and simple control of power outputs in welding systems is desirable.

### SUMMARY

The present disclosure is directed to systems and methods for controlling isolation circuitry in a welding device based on one or more power characteristics, substantially as illustrated by and/or described in connection with at least one of the figures, and as set forth in the claims.

These and other advantages, aspects and novel features of the present disclosure, as well as details of an illustrated example thereof, will be more fully understood from the following description and drawings.

### DRAWINGS

FIG. 1 illustrates an example welding-type system to control isolation circuitry in a welding device, in accordance with aspects of this disclosure.

FIG. 2 illustrates an example welding device that includes isolation circuitry, in accordance with aspects of this disclosure.

FIG. 3 provides a flowchart representative of example machine-readable instructions which may be executed by the example system of FIGS. 1 and 2 to control an isolation circuitry, in accordance with aspects of this disclosure.

FIG. 4 provides a flowchart representative of another example machine-readable instructions which may be executed by the example system of FIGS. 1 and 2 to control an isolation circuitry, in accordance with aspects of this disclosure.

The figures are not necessarily to scale. Where appropriate, similar or identical reference numbers are used to refer to similar or identical components.

### DETAILED DESCRIPTION

The present disclosure is directed to systems and methods for controlling isolation circuitry in a welding device based on one or more power characteristics. In disclosed examples, a power supply and welding device (e.g., a wire feeder) are provided to support both arc welding and gouging operations. To ensure power at an output power terminal is available only during periods of operation, isolation circuitry is provided in the wire feeder. For example, the isolation circuitry is operable to create a path between a input power terminal and an output terminal during an arc welding and/or gouging operation, and to electrically or physically disrupt the path between the input power terminal and the output power terminal during an idle or standby mode. In some examples, more than a single point of isolation may exist between the input power terminal and the output power terminal.

Conventionally, contactors have been placed in welding equipment to serve as an interlock between an input and an output. However, arc welding and gouging operations tend to require high power outputs, such that contactors have a high power rating. To maintain such a contactor in a given state (e.g., to disengage the contactor during a period of non-use), a significant amount of power is required. Thus, if a power supply (e.g., an engine driven power generator) is idling (e.g., the engine is not turning, thereby not consuming unnecessary fuel), the power needed to maintain the contactor may not be available.

In disclosed examples, welding systems are provided that employ low power relays, circuitry, switches, and/or other electrical components to monitor power characteristics between an power input terminal and an power output terminal, and control engagement and/or disengagement of the contactor.

Some welding wire feeders are defined as voltage-sensing wire feeders, which draw power from a welding arc, among other characteristics unique from standard wire feeders.

In disclosed examples, isolation circuitry (e.g., an isolating contactor, an electrical or mechanical interlock, etc.) is operable to control a process isolated output for one or more welding-type outputs, such as arc welding and/or carbon arc gouging.

In some examples, the isolation circuitry is an isolating contactor, such as a magnetically latching type contactor operable to ensure output power continuity during a gouge process, while limiting the power required to employ the contactor coil during a gouging process and/or idling of the system.

In some arrangements, an output could remain active without the wire feeder being powered on, and therefore in control of the output. Such an possibility could impact product reliability as well as raise performance issues.

To ensure the output would not be active (e.g., provide an electrical output) when the wire feeder was not controlling the output (e.g., powered down), the disclosed isolating contactor is selected as a non-latching type contactor. However, in some applications this type of non-latching contactor employs a significant amount of power to remain engaged. This creates issues for many systems, as an idle state may not generate and/or provide sufficient power to the wire feeder and/or contactor to ensure the power output is limited (or off). For instance, a low-open circuit voltage (OCV) power supply often requires significant current and/or power output to maintain contactor engagement.

In view of these challenges, disclosed isolation circuitry operable during times of idling implemented with power saving measures are described herein.

In some examples, a contactor of sufficient power rating is used to isolate a welding output terminal from a power input, such as to power an electric welding arc. In examples, a monitoring circuit can be arranged in parallel with the contactor creating an alternate path from the power input to the power output. In some examples, monitoring circuit is arranged in series with the relay.

In some examples, the monitoring circuit can detect a power characteristic (e.g., voltage, current, power, impedance, etc.) along the path between the power input and the power output. For example, the controller can determine an absolute value of the power characteristic at the input and/or output terminals, and/or determine a change in the power characteristic, including rate of change. The controller is operable to determine if or when a value of the power characteristic has violated a threshold value and respond accordingly. In alternative or additional examples, a relay (e.g., with a smaller power rating relative to the contactor) and/or switch is arranged in parallel with the contactor.

In disclosed example, the controller may determine a value of the power characteristics have violated a particular threshold (e.g., dropped below, exceeded), such that a period of inactivity has been maintained for a predetermined amount of time. Upon determining the system has entered a prolonged period of inactivity, the isolating contactor can be disengaged.

In some examples, the monitoring circuit is or includes a current limiting resistance circuit (e.g., a resistor) connected to a power output terminal.

In view of the foregoing, disclosed are systems and method that require a relatively small amount of power to sense/monitor power characteristics at and/or between input and/or output power terminals and control isolation circuitry accordingly. Consistent monitoring of the power characteristics, such as during idle modes, ensures the isolation circuitry remains disengaged during idle or powered down modes. Further, once a welding process commences and the controller determines power is being provided to the output power terminal, the isolating contactor can be powered by full active arc welding and/or gouging power output of the power supply 10.

This idea is unique in that the wire feeder (or other accessory device) enables a welding process without communicating with the power supply. When connected to a fully featured power supply, power for the appropriate process and/or mode will be monitored and an appropriate determination made (e.g., at the controller and/or relay), and the isolation circuitry will be engaged and/or disengaged accordingly. In addition, the wire feeder will engage and/or disengage the isolation circuitry independently of the power supply. The isolation function that occurs in the wire feeder will work regardless of the capabilities of the power supply in the system.

Advantageously, the discloses systems and methods allows for a reduction in power consumption of the accessory (e.g., wire feeder) while the welding system is in an idle or standby mode. This feature offers increased value when the wire feeder is connected to a power supply that exhibits an OCV state when in idle or standby mode.

Further, ensuring engagement of the isolating contactor only during periods of active welding and/or gouging avoids inadvertent contact with an energized output power terminal.

Furthermore, employing a monitoring circuit and/or relay to ensure desired engagement and/or disengagement of the isolation circuitry (e.g., in an idle or standby mode) provides a low power and low cost solution to power management.

The term “welding-type system,” as used herein, includes any device capable of supplying power suitable for welding, plasma cutting, induction heating, Carbon Arc Cutting-Air (e.g., CAC-A, or gouging), and/or hot wire welding/preheating (including laser welding and laser cladding), including inverters, converters, choppers, resonant power supplies, quasi-resonant power supplies, etc., as well as control circuitry and other ancillary circuitry associated therewith.

As used herein, the term “welding-type power” refers to power suitable for welding, plasma cutting, induction heating, CAC-A and/or hot wire welding/preheating (including laser welding and laser cladding).

As used herein, the term “welding-type power supply” and/or “power supply” refers to any device capable of, when power is applied thereto, supplying welding, plasma cutting, induction heating, CAC-A and/or hot wire welding/preheating (including laser welding and laser cladding) power, including but not limited to inverters, converters, resonant power supplies, quasi-resonant power supplies, and the like, as well as control circuitry and other ancillary circuitry associated therewith. The term can include engine driven power supplies, energy storage devices, and/or circuitry and/or connections to draw power from a variety of external power sources.

As used herein, the term “wire feeder” includes the motor or mechanism that drives the wire, the mounting for the wire, and controls related thereto, and associated hardware and software.

As used herein, the term “torch,” “welding torch,” “welding tool” or “welding-type tool” refers to a device configured to be manipulated to perform a welding-related task, and can include a hand-held welding torch, robotic welding torch, gun, gouging tool, cutting tool, or other device used to implement a welding process.

As used herein, a “circuit,” or “circuitry,” includes any analog and/or digital components, power and/or control elements, such as a microprocessor, digital signal processor (DSP), software, and the like, discrete and/or integrated components, or portions and/or combinations thereof.

The terms “control circuit,” “control circuitry,” and/or “controller,” as used herein, may include digital and/or analog circuitry, discrete and/or integrated circuitry, microprocessors, digital signal processors (DSPs), Field Programmable Gate Arrays (FPGAs), and/or other logic circuitry, and/or associated software, hardware, and/or firmware. Control circuits or control circuitry may be located on one or more circuit boards that form part or all of a controller, and are used to control a welding process, a device such as a power source or wire feeder, and/or any other type of welding-related system.

As used herein, the term “memory” includes volatile and non-volatile memory devices and/or other storage device.

As used herein, the term “energy storage device” is any device that stores energy, such as, for example, a battery, a supercapacitor, etc.

As used herein, the term “welding mode,” “welding process,” “welding-type process” or “welding operation” refers to the type of process or output used, such as current-controlled (CC), voltage-controlled (CV), pulsed, gas metal arc welding (GMAW), flux-cored arc welding (FCAW), gas tungsten arc welding (GTAW, e.g., TIG), shielded metal arc welding (SMAW), spray, short circuit, CAC-A, gouging process, plasma cutting, cutting process, and/or any other type of welding process.

As used herein, the term “welding program” or “weld program” includes at least a set of welding parameters for controlling a weld. A welding program may further include other software, algorithms, processes, or other logic to control one or more welding-type devices to perform a weld.

As used herein, “power conversion circuitry” and/or “power conversion circuits” refer to circuitry and/or electrical components that convert electrical power from one or more first forms (e.g., power output by a generator) to one or more second forms having any combination of voltage, current, frequency, and/or response characteristics. The power conversion circuitry may include safety circuitry, output selection circuitry, measurement and/or control circuitry, and/or any other circuits to provide appropriate features.

As used herein, the term “boost converter” is a converter used in a circuit that boosts a voltage. For example, a boost converter can be a type of step-up converter, such as a DC-to-DC power converter that steps up voltage while stepping down current from its input (e.g., from the energy storage device) to its output (e.g., a load and/or attached power bus). It is a type of switched mode power supply.

As used herein, the term “buck converter” (e.g., a step-down converter) refers to a power converter which steps down voltage (e.g., while stepping up current) from its input to its output.

As used herein, the terms “first” and “second” may be used to enumerate different components or elements of the same type, and do not necessarily imply any particular order.

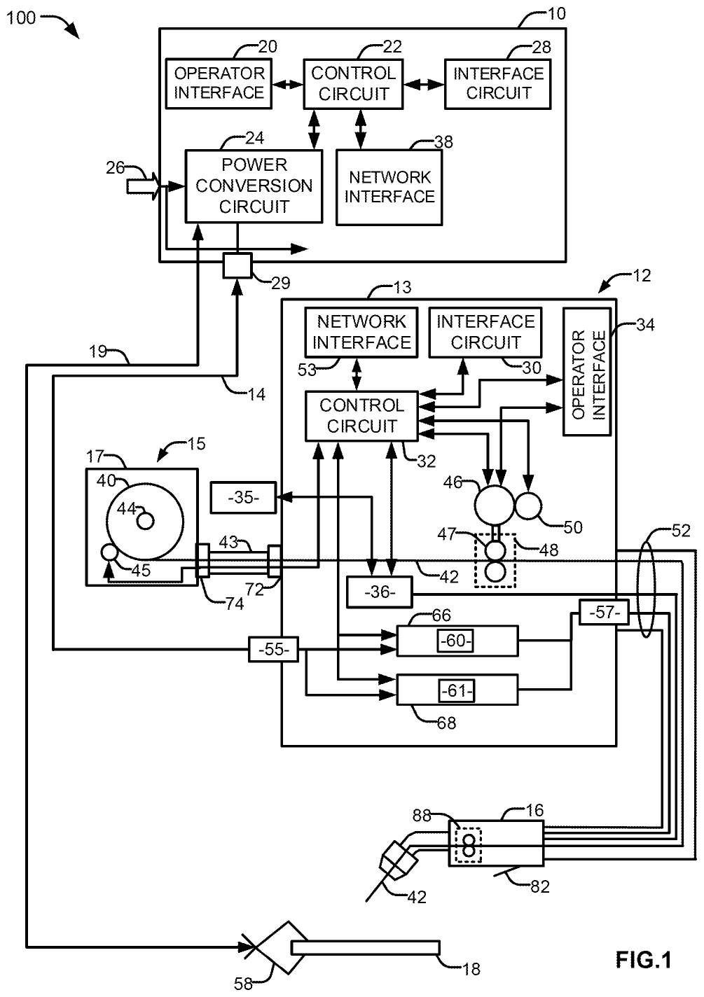

FIG. 1 illustrates an example welding system 100 for performing welding operations. As shown in the welding system 100 of FIG. 1, a power supply 10 and a welding device (e.g., wire feeder or other accessory) 12 are coupled via conductors or conduits 14. In the illustrated example, the power supply 10 is separate from the wire feeder 12, such that the wire feeder 12 may be positioned near a welding location at some distance from the power supply 10. Terminals are typically provided on the power supply 10 and on the wire feeder 12 to allow the conductors 14 or conduits to be coupled to the systems so as to allow for power and gas to be provided to the wire feeder 12 from the power supply 10, and to allow data to be exchanged between the two devices.

The system 100 is configured to provide wire from a welding wire source 15, power from the power supply 12, and shielding gas from a shielding gas supply 35, to a welding tool or torch 16. The torch 16 may be any type of arc welding torch, (e.g., GMAW, GTAW, FCAW, SMAW) and may allow for the feed of a welding wire 42 (e.g., an electrode wire) and gas to a location adjacent to a workpiece 18, responsive to a trigger 82. A work cable 19 is run to the welding workpiece 18 so as to complete an electrical circuit between the power supply 10 and the workpiece 18.

The welding system 100 is configured for weld settings (e.g., weld parameters, such as voltage, wire feed speed, current, gas flow, inductance, physical weld parameters, advanced welding programs, pulse parameters, etc.) to be selected by the operator and/or a welding sequence, such as via an operator interface 20 provided on the power supply 10. The operator interface 20 will typically be incorporated into a front faceplate of the power supply 10, and may allow for selection of settings such as the weld process, the type of wire to be used, voltage and current settings, and so forth. In particular, the example system 100 is configured to allow for welding with various steels, aluminums, or other welding wire that is channeled through the torch 16. Further, the system 100 is configured to employ welding wires with a variety of wire sizes. These weld settings are communicated to a control circuit 22 within the power supply 10. The system may be particularly adapted to implement welding regimes configured for certain electrode types. The control circuit 22 operates to control generation of welding power output that is supplied to the welding wire 42 for carrying out the desired welding operation.

The torch 16 applies power from the power supply 10 to the wire electrode 42, typically by a conductor connected to terminal 57 extending through a welding cable 52. Similarly, shielding gas from a shielding gas supply 35 is fed through the wire feeder 12 and the welding cable 52. During welding operations, the welding wire 42 is advanced through a jacket of the welding cable 52 towards the torch 16.

The work cable 19 and clamp 58 allow for closing an electrical circuit from the power supply 10 through the welding torch 16, the electrode (wire) 42, and the workpiece 18 for maintaining the welding arc during the operation. In addition to torch 16 in some examples multiple torches of a variety of types may be connected to the wire feeder 12. In examples, a gouging or cutting torch may be separately connected to the wire feeder 12 and/or the power supply 10.

In some examples, the wire feeder 12 is a voltage sensing wire feeder. A work sensing line can be coupled to the power supply 10 and the work piece 18 to enable the power supply 10 to detect the polarity even when no welding operation is active. More specifically, the work sensing line completes an electrical circuit between the power supply 10, the wire feeder 12, the work piece 18, and back to the power supply 10 to enable the polarity to be detected. For example, detection of the polarity may include sensing a voltage at output 57, a current flowing through the cable 52, or both.

The control circuit 22 is coupled to a power conversion circuit 24. This power conversion circuit 24 is adapted to create the output power, such as pulsed waveforms applied to the welding wire 42 at the torch 16. Various power conversion circuits may be employed, including choppers, boost circuitry, buck circuitry, inverters, converters, and/or other switched mode power supply circuitry, and/or any other type of power conversion circuitry. The power conversion circuit 24 is coupled to a source of electrical power as indicated by arrow 26. The power applied to the power conversion circuit 24 may originate in the power grid, although other sources of power may also be used, such as power generated by an engine-driven generator, batteries, fuel cells or other alternative sources. The power supply 10 illustrated in FIG. 1 may also include an interface circuit 28 configured to allow the control circuit 22 to exchange signals with the wire feeder 12 and/or other auxiliary devices.

The wire feeder 12 includes a complimentary interface circuit 30 that is coupled to the interface circuit 28. In some examples, multi-pin interfaces may be provided on both components and a multi-conductor cable run between the interface circuit to allow for such information as wire feed speeds, processes, selected currents, voltages or power levels, and so forth to be set on either the power supply 10, the wire feeder 12, or both. Additionally or alternatively, the interface circuit 30 and the interface circuit 28 may communicate wirelessly and/or via the weld cable. In some examples, power supply 10 may communicate with the wire feeder 12 (and or another remote device) using weld cable communications (WCC) through the welding torch cable 14.

The wire feeder 12 also includes control circuit 32 coupled to the interface circuit 30. As described below, the control circuit 32 allows for wire feed speeds to be controlled in accordance with operator selections or stored sequence instructions, and permits these settings to be fed back to the power supply 10 via the interface circuit. The control circuit 32 is coupled to an operator interface 34 on the wire feeder that allows selection of one or more welding parameters, such as wire feed speed. The operator interface may also allow for selection of such weld parameters as the welding process type (including arc welding operation and/or gouging operation), the type of wire utilized, current, voltage or power settings, and so forth.

In some examples, the wire feeder 12 includes isolation circuitry 66. For instance, the isolation circuitry 66 in the wire feeder 12 may include an isolating contactor 60 to control power flow between input power terminal 55 and output power terminal 57. A monitoring circuit 68 may be arranged in parallel with isolation circuitry 66, and include one or more sensors, relays, contactors, switches, and/or other components to monitor and/or control power characteristics between terminals 55 and 57.

The control circuit 32 may also be coupled to gas control valving 36 which regulates and/or measures the flow of shielding gas from the shielding gas supply 35 to the torch 16. In general, such gas is provided at the time of welding, and may be turned on immediately preceding the weld and for a short time following the weld. The shielding gas supply 35 may be provided in the form of pressurized bottles.

The wire feeder 12 includes components for feeding wire to the welding torch 16 and thereby to the welding operation, under the control of control circuit 32. As illustrated, the drive components and control components of the wire feeder 12 are included within a first housing or enclosure 13. In some examples, a spool of wire 40 is mounted on a spool hub 44 in a second housing or enclosure 17. The wire source 15 may be integrated with the wire feeder 12. In some examples, the wire source 15 is physically independent from the wire feeder 12. In other words, the wire source 15 is connectable to and disconnectable from the wire feeder 12, and the wire source 15 can be physically moved independently from the wire feeder 12.

In some examples, the spool hub 40 is configured to support up to a sixty pound spool of wire and the enclosure 17 is large enough to enclose a sixty pound spool of wire. An inlet 72 of the wire feeder 12 is connected to an outlet 74 of the wire source 15 via one or more connectors 43. In some examples, the wire feeder inlet 72 is directly connected to the wire source outlet 74. For example, the wire feeder inlet 72 may include a first connector that directly connects to a second connector of the wire source outlet 74. For example, the wire feeder inlet 72 may connect to the wire source outlet 74 via quick disconnect connectors or the like through which wire from the spool 40 may be fed. In some examples, a conduit may connect the wire feeder inlet 72 to the wire source outlet 74. In some examples, the conduit is flexible (e.g., similar to a weld cable). In some examples, the conduit may be a rigid conduit. The connectors 43 enable welding wire 42 from the spool 40 to be fed to the drive components of the wire feeder 12. The connectors 43 may also enable one or more control cables to be connected from components within the wire source enclosure 17 to the control circuit 32.

Welding wire 42 is unspooled from the spool 40 and is progressively fed to the torch 16. The spool 40 may be associated with a clutch 45 that disengages the spool 40 when wire is to be fed from the spool 40 to the torch 16. The clutch 45 may also be regulated, for example by the control circuit 32, to maintain a minimum friction level to avoid free spinning of the spool 40. The first wire feeder motor 46 engages with wire feed rollers 47 that may be provided within a housing 48 to push wire 42 from the wire feeder 12 towards the torch 16.

In practice, at least one of the rollers 47 is mechanically coupled to the motor 46 and is rotated by the motor 46 to drive the wire from the wire feeder 12, while the mating roller is biased towards the wire to apply adequate pressure by the two rollers to the wire. Some systems may include multiple rollers of this type. In some examples, the wire feeder 12 is configured to feed ⅛ inch wire. In some examples, the wire feeder 12 is configured to feed 3/32 inch wire, or any other suitable size or type of wire.

A tachometer 50 or other sensor may be provided for detecting the speed of the first wire feeder motor 46, the rollers 47, or any other associated component so as to provide an indication of the actual wire feed speed. Signals from the tachometer 50 are fed back to the control circuit 32 such that the control circuit 32 can track the length of wire that has been fed. The length of wire may be used directly to calculate consumption of the wire and/or the length may be converted to wire weight based on the type of wire and its diameter.

In some examples, a second wire feeder 88 is included. The wire feeder 88 may be incorporated within the torch 16 and/or at a location along the path of the electrode wire 42. The wire feeder 88 may be controlled by the control circuitry 32 to coordinate with wire feed rollers 47 to advance and/or retract the electrode wire 42 based on a desired application.

As shown in FIG. 1, the isolation circuitry 66 includes isolating contactor 60. In some examples, a monitoring circuit 68 is configured to monitor one or more power characteristics between the input power terminal 55 and the output power terminal 57. For example, the monitoring circuit 61 may measure, sense or otherwise monitor power characteristics, and trigger engagement of the isolating contactor 60, and/or transmit information corresponding to the characteristics to control circuits 22, 32. Power output terminal 57 is a welding power output configured to provide welding power to torch 16 via cable 52. In some examples, power output terminal 57 is configured to provide power to a gouging torch. In some examples, the isolation circuitry 66 is additionally or alternatively configured to physically or electrically disconnect a circuit between the input power terminal 55 and the output power terminal 57. For instance, the isolating contactor 60 can break contact with conductors connecting terminals 55 and 57, preventing the flow of power therebetween.

In some additional or alternative examples, monitoring circuit 61 includes a relay, switch or other suitable feature (e.g., an interlock, a contactor, etc.) configured to respond to a change in a power characteristic between terminals 55 and 57.

A memory device may store processor executable instructions (e.g., firmware or software) for the control circuitry 32 or control circuitry 56 to execute. In addition, one or more control regimes for various welding processes (e.g., MIG or GTAW welding process, CAC-A plasma cutting, etc.), along with associated settings and parameters, may be stored in the memory device, along with code configured to provide a specific output (e.g., output power, power characteristics, change in polarity, initiate wire feed or set wire feeder speed, enable gas flow, wire feeder direction, travel speed, process mode, deposition path, deposition sequence, torch angle, etc.) during operation. In some examples, threshold values associated with power characteristics to determine operation of the isolation circuitry are accessible to the control circuitry. One or more lists or look up tables may be provided, and/or network connections to various databases available to inform decision-making, such as to access preferred output parameters, to store updated parameter settings, etc.

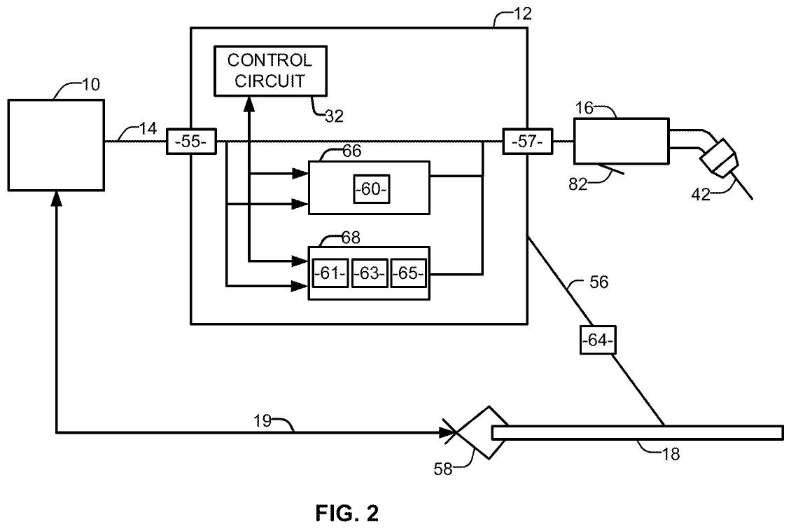

FIG. 2 shows the wire feeder 12 connected to the power supply 10 and the wire feeder 12 via cable 14. As shown, the isolation circuitry 66 includes isolating contactor 60, which engages in response to a power characteristic between terminals 55 and 57 violating an applicable threshold value. For example, monitoring circuitry 68 includes a monitoring circuit 61 (e.g., a sensor, resistor, etc.) configured to monitor one or more power characteristics between the input power terminal 55 and the output power terminal 57. For example, the monitoring circuit 61 may measure, sense or otherwise monitor power characteristics, and transmit information corresponding to the characteristics to control circuit 22, 32. Based on the power characteristic information, the control circuit(s) can engage and/or disengage the isolation circuitry 66.

In additional or alternative examples, monitoring circuitry 68 includes a relay 63 (e.g., a pilot relay). The relay 63 can operate under a relatively small amount of power, such as an energy storage device located within the wire feeder 12. For instance, the relay 63 can be triggered by a change in voltage between terminals 55 and 57 beyond a threshold amount, such that a change indicative of contact between the torch 16 and the workpiece 18. In response, a signal can be transmitted to the control circuits 22, 32 that a welding operation is commencing, and the isolation circuit 66 engages to allow welding-type power to flow between terminals 55 and 57. In some examples, a current limiting element 65 (e.g., a resistor) is arranged with the monitoring circuit 68 to ensure a threshold amount of power is transmitted to the relay 63 as a welding process commences.

Along wire sensing cable 56, a circuit 64 (e.g., including one or more current limiting elements, such as resistors) is arranged to ensure a threshold amount of power is needed to activate the isolation circuit 60. For example, in an idle or standby mode, the relay 63 is energized presenting the electrode voltage at a power output terminal (e.g., a gouge output terminal), with current at the power output terminal being limited by current limiting resistance circuit 65. A voltage at the output power terminal 57 is monitored and compared to a voltage at a workpiece (e.g., via control circuits 22, 32). The value of resistance circuit 65 and a predetermined voltage threshold at circuit 64 allow for detection of the welding device to the workpiece, indicating a desired welding operation has commenced, while rejecting inadvertent or physical contact with the output. Thus, upon sensing the output electrode 42 connection making valid contact with the workpiece 18, the isolating contactor 60 is engaged, thereby enabling power to flow to the output power terminal 57 and commence the process operation.

In view of the foregoing, a relatively small amount of power is needed to operate the monitoring circuit 68 (e.g., including sensor 61, relay 63) to ensure the isolating contactor 60 remains disengaged during idle or powered down modes. Further, once a welding process commences, the isolating contactor 60 can be powered by the full active weld/gouge output of the power supply 10.

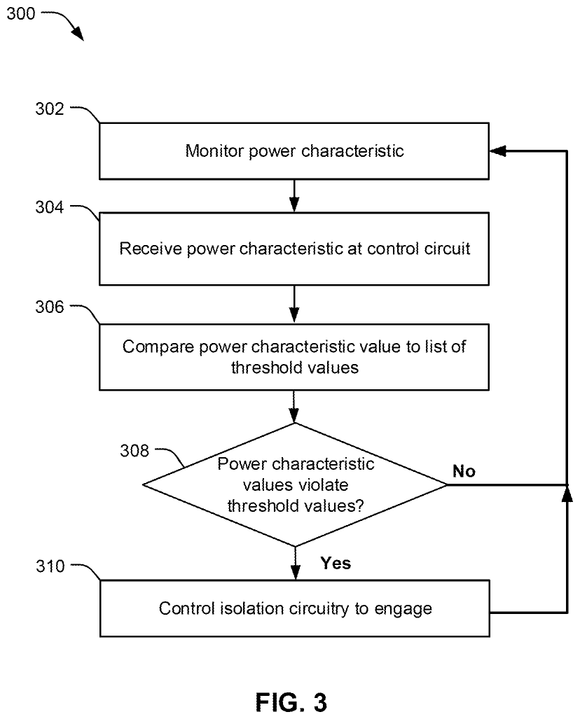

FIG. 3 shows a flowchart representative of example machine readable instructions 300 which may be executed by the control circuitry 22 and/or 32 of FIG. 1 for activating isolation circuitry, as disclosed herein. In block 302, monitoring circuitry monitors a power characteristic between input and output power terminals. For example, the terminals can be arranged in a welding accessory, such as a wire feeder, and be configured to receive power from a welding-type power supply.

At block 304, the power characteristic is received at control circuitry (e.g., control circuitry 22, 32). At block 306, the control circuitry compares values associated with the power characteristic to a list of threshold power characteristic values (e.g., stored in a memory). At block 308, the control circuitry determines whether the power characteristic violates a corresponding power characteristic threshold value. If the power characteristic value does not violate a corresponding power characteristic threshold value, the method 300 returns to block 302.

If the power characteristic value violates (e.g., exceeds) a corresponding power characteristic threshold value, the control circuitry controls isolation circuitry to engage at block 310. For example, an isolating conductor of the isolation circuitry can be engaged to close a path between input and output terminals to provide power for a welding operation.

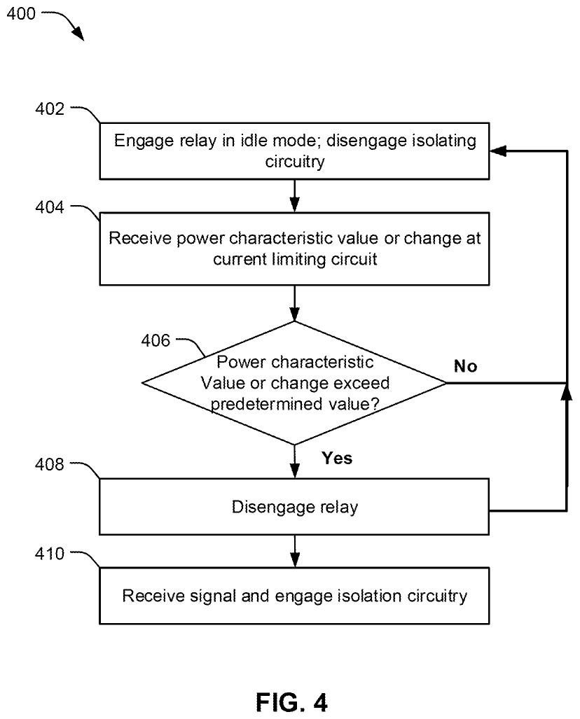

FIG. 4 shows a flowchart representative of example machine readable instructions 400 which may be executed by the control circuitry 22 and/or 32 of FIG. 1 for activating isolation circuitry, in another disclosed example. In block 402, a relay is engaged in an idle mode (e.g., during a period of no activity), thereby causing isolation circuitry to disengage and breaking the current path between input and output power terminals.

At block 404, a signal representative of a change in power is received at a current limiting circuit associated with the relay. At block 406, if the power characteristic does not exceed a predetermined value associated with the current limiting circuit, the method 400 returns to block 402.

If the power characteristic value exceeds the predetermined value, the relay disengages at block 408. At block 410, a signal indicating the relay has disengaged is provided to the isolation circuitry (e.g., via the control circuit), causing the isolation circuitry to engage. For example, an isolating conductor of the isolation circuitry can be engaged to close a path between input and output terminals to provide power for a welding operation.

The present methods and systems may be realized in hardware, software, and/or a combination of hardware and software. Example implementations include an application specific integrated circuit and/or a programmable control circuit.

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled or not enabled (e.g., by a user-configurable setting, factory trim, etc.).

While the present method and/or system has been described with reference to certain implementations, it will be understood by those skilled in the art that various changes may be made and equivalents may be substituted without departing from the scope of the present method and/or system. For example, block and/or components of disclosed examples may be combined, divided, re-arranged, and/or otherwise modified. In addition, many modifications may be made to adapt a particular situation or material to the teachings of the present disclosure without departing from its scope. Therefore, the present method and/or system are not limited to the particular implementations disclosed. Instead, the present method and/or system will include all implementations falling within the scope of the appended claims, both literally and under the doctrine of equivalents.

What is claimed is:

1. A welding system, comprising:
isolation circuitry between a power input and a power output to automatically isolate the power input from the power output;
a monitoring circuit; and
control circuitry configured to:
control the isolation circuitry to disengage in the idle mode;
monitor a change in a power characteristic at the monitoring circuit; and
engage the isolation circuitry in response to a power characteristic change
at the circuit monitor greater than a threshold characteristic value.

2. The welding system of claim 1, wherein the power characteristic is voltage.

3. The welding system of claim 2, wherein the control circuitry is further configured to determine a voltage change exceeds a threshold voltage value, wherein the voltage change exceeding the threshold voltage value corresponds to activation of a welding mode resulting in a closed circuit between an electrode wire and a workpiece.

4. The welding system of claim 1, wherein the power output includes welding power circuitry or gouging power circuitry.

5. The welding system of claim 1, wherein the welding system is a wire feeder.

6. The welding system of claim 1, wherein the isolation circuitry comprises a contactor.

7. The welding system of claim 1, wherein the isolation circuitry includes a physical interlock comprising one or more of a relay, a contactor, or a switch.

8. The welding system of claim 1, wherein an input power at the power input is less than 100 mW during the idle mode.

9. The welding system of claim 1, wherein an input power at the power input is greater than 10 W during a welding mode.

10. The welding system of claim 1, wherein the isolation circuitry is configured to electrically or physically isolate the output power terminal from the input power terminal.

11. The welding system of claim 1, further comprising a user interface to receive a command to provide the welding power input or to enter the idle mode.

12. A system, comprising:
a welding power supply to supply a power output; and
a wire feeder coupled between the welding power supply and one or more welding torches, the wire feeder comprising:
isolation circuitry between a welding power input and a welding power output to automatically isolate the welding power input from the welding power output;
a monitoring circuit; and
control circuitry configured to:
control the isolation circuitry to disengage in the idle mode;
monitor a change in a power characteristic at the monitoring circuit; and
engage the isolation circuitry in response to a power characteristic change at the circuit monitor greater than a threshold characteristic value.

13. The system of claim 12, wherein the wire feeder is located remotely from the welding power supply and proximate to the one or more welding torches.

14. The system of claim 12, wherein the one or more welding torches includes a welding torch to perform a welding operation and a gouging torch to perform a gouging operation.

15. The system of claim 12, wherein the wire feeder is a voltage-sending wire feeder.

16. A welding system, comprising:
isolation circuitry between a welding power input and a welding power output to automatically isolate the welding power input from the welding power output;
a relay circuit;
a circuit monitor; and
control circuitry configured to:
control the relay circuit to engage in an idle mode;
control the isolation circuitry to disengage in the idle mode;
monitor a change in voltage at the current limiting circuit; and
engage the isolation circuitry in response to a voltage change at the circuit monitor greater than a threshold voltage value.

17. The welding system of claim 16, wherein the relay circuit is in electrical communication with a current limiting circuit.

18. The welding system of claim 17, wherein the relay circuit configured to disengage in response to a voltage increase at the current limiting circuit greater than a threshold voltage value, causing the isolation circuitry to engage closing a circuit between the welding power input and the welding power output.

19. The welding system of claim 16, wherein the current limiting circuit comprises one or more resistors arranged in series between the relay circuit and the workpiece.

20. The welding system of claim 16, wherein the relay circuit and the current limiting circuit are arranged in parallel with the isolation circuitry.
